(19) United States
(12) Patent Application Publication
(10) Pub. No.: US 2009/0089690 A1
(43) Pub. Date: Apr. 2, 2009

(54) SYSTEM AND METHOD FOR IMPROVED TAG ENTRY FOR A CONTENT ITEM

(75) Inventors: Liang-Yu Chi, San Francisco, CA (US); Pam Huey, Vancouver (CA); Nathan Arnold, Toronto (CA)

Correspondence Address: YAHOO! INC.;C/O Ostrow, Kaufman & Frankl LLP, 136 E. 57th Street, 12th Floor, NEW YORK, NY, 10022, US

(73) Assignee: YAHOO! INC., Sunnyvale, CA (US)

(21) Appl. No.: 11/863,460

(22) Filed: Sep. 28, 2007

(51) Int. Cl. G06F 3/048

(52) U.S. Cl. 715/764

(57) ABSTRACT

Embodiments of the present invention provide systems, methods and computer program products for associating one or more tags with a content item. One embodiment of a method for tag entry comprises receiving a request to input one or more tags, providing one or more tag input fields through the use of a graphical user interface, receiving a tag input in a given one of the one or more tag input fields and loading one or more input tags into a tag storage object for persistent storage of the tags. In providing multiple input fields, embodiments of the present invention provide an improved method for tag entry by allowing for efficient input of tags by an inexperienced user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to tag entry for a content item. More specifically, the present invention provides systems, methods and computer program products for improved tag entry, tag saving and tag editing for one or more tags associated with a content item.

### BACKGROUND OF THE INVENTION

A tag is a keyword or term associated with or assigned to a content item, such as a webpage, a digital image, a video clip or an internet bookmark, which serves to describe the content item and enable keyword-based classification of the content item. Tags are typically chosen informally and personally by end users who use a content item and assign one or more tags to the content item through the bookmarking process. As the digital environment continues to expand, the number of users of content items has increased dramatically. Inherent in the increase of the number of users who view and interact with content items is an increase in the number of users who are typically inexperienced with methods for tag entry. As the determination of tags is typically personal to users who interact with content items, however, inexperienced users are now faced with the task of performing tag entry for a given content item.

Current techniques for associating tags with a content item allow for a tag entry whereby users enter multiple keywords or tags into a single input field, using only one or more specific enumerated delimiters, e.g. commas, spaces, etc., to separate or distinguish among multiple tags. Such tag entry techniques, however, may only be efficiently utilized by experienced users or users who can carefully and patiently enter tags in the current systems. Inexperienced users typically experience difficulty in the efficient or proper input of tags, usually due to unfamiliarity with the concept of tags and the use of delimiters to provide multiple tags within a single input field. Furthermore, current systems do not provide support to inexperienced users, such as by failing to provide an easy deletion or edit mechanism or automatic inclusion of system-suggested tags.

Therefore, there exists a need for systems, methods and computer program products that provide improved tag entry, tag saving and tag editing for one or more tags associated with a content item

### SUMMARY OF THE INVENTION

Generally, the present invention provides for an improved method, system and computer program product for associating one or more tags with a content item. As described above, a content item may a piece of information, such as a webpage, a digital image, a video clip or an internet bookmark. Associating or assigning a tag or relevant keyword to a content item is typically an informal process, where the tags or keywords chosen are personal to an end user who interacts with the content item.

The present invention is directed toward a method of associating one or more tags with a content item and includes receiving a request to input one or more tags, providing one or more tag input fields through the use of a graphical interface, receiving a tag input in a given one of the one or more input fields and loading one or more tag inputs into a tag storage object for persistent storage of the tag. The present invention also provides for a system for associating one or more tags with a content item which comprises a graphical user interface which is operative to receive a request to input one or more tags and a tag component which is operative to provide one or more tag input fields through the use of the graphical user interface, receive a tag input in a given one of the one or more tag input fields and load the tag from a given one of the one or more tag input fields into a tag storage object for persistent storage of the tag.

In providing multiple input fields, the present invention provides an improved method for tag entry allowing an inexperienced user to input tags efficiently. The multiple input fields clearly indicate and suggest to users that multiple tags can be entered and associated with a content item. The present invention also allows for the inclusion of characters in a given tag which would otherwise be reserved for tag-delimitation in other tag entry systems. The present inventions further allows for an automatic inclusion of system suggested tags, as well as simple delete and edit functions, contrary to current tag entry systems.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for entering and associating one or more tags with a content item according to one embodiment of the present invention;

FIG. 2 illustrates a flow diagram presenting a method for entering and associating one or more tags with a content item according to one embodiment of the present invention;

FIG. 3 illustrates a flow diagram presenting a method for entering and associating one or more tags with a content item using system-suggested tags according to one embodiment of the present invention;

FIG. 4 illustrates a flow diagram presenting a method for providing additional input tag fields according to one embodiment of the present invention;

FIG. 5 illustrates a flow diagram presenting a method for providing additional input tag fields according to another embodiment of the present invention;

FIG. 6 illustrates a flow diagram presenting a method for entering and associating one or more tags with a content item using auto-suggested tags according to one embodiment of the present invention;

FIG. 7 illustrates a series of sample screen images for entering and associating one or more tags with a content item according to one embodiment of the present invention; and

FIG. 8 illustrates a series of sample screen images for entering and associating one or more tags with a content item according to one embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

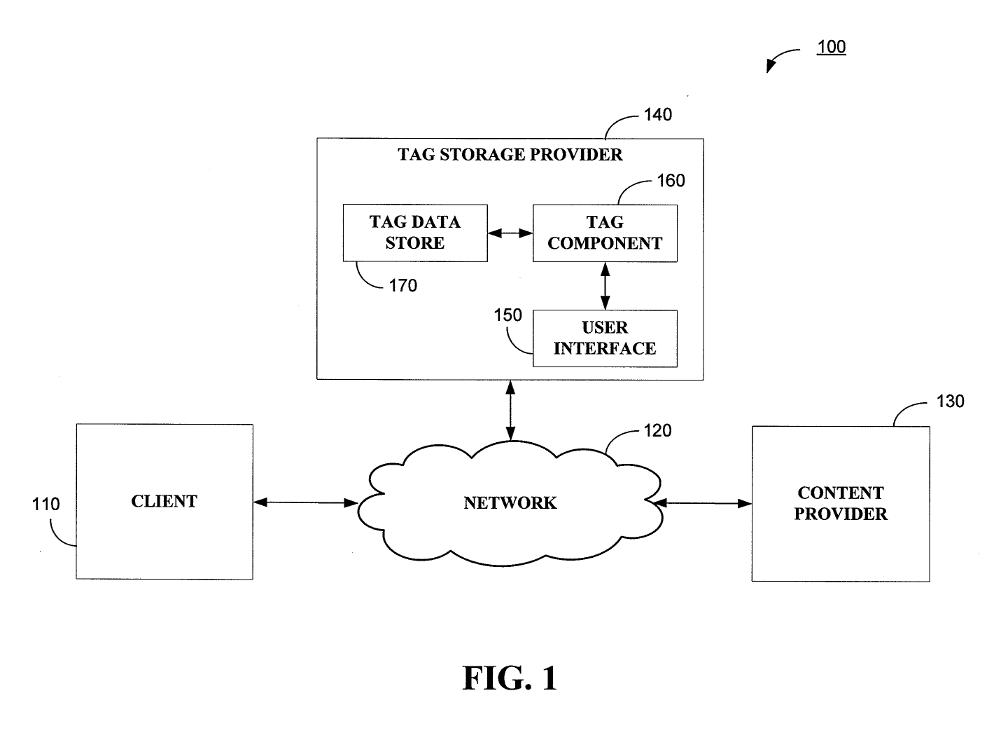

FIG. 1 illustrates one embodiment of a system for tag entry 100 that includes one or more clients 110, a computer network 120, a content provider 130, and a tag storage provider 140. The tag storage provider 140 comprises a graphical user interface 150, a tag component 160 and a tag data store 170.

The computer network 120 may be any type of computerized network capable of transferring data, such as the Internet. According to one embodiment of the invention, a given client device 110 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

The tag component 160 may comprise one or more processing elements operative to perform processing operations in response to executable instructions, collectively as a single element or as various processing modules. The tag data store 170 may be one or more data storage devices of any suitable type, operative to store corresponding data therein. Those of skill in the art recognize that the tag storage provider 140 may utilize more or fewer components and data stores, which may be local or remote with regard to a given component or data store.

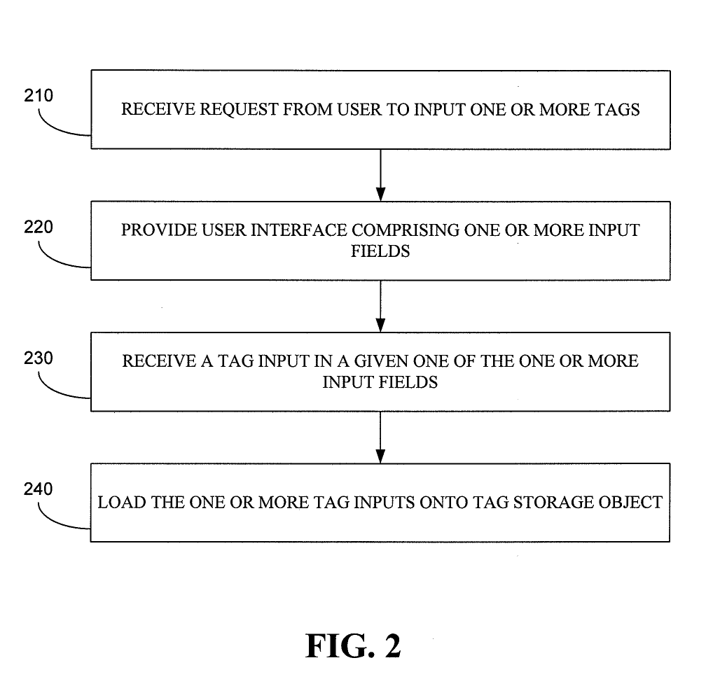

In accordance with one embodiment, the client 110 communicates across the computer network 120 with the content provider 130 and may transmit one or more search queries which may comprise one or more terms. Alternatively, or in conjunction with the foregoing, the client 110 may access one or more content items that the content provider 130 makes available over the computer network 120. The content provider 130 transmits one or more content items in response to the one or more search queries to the client 110. The client 110 transmits a request to the tag storage provider 140 to input one or more tags over the computer network 120 onto a tag storage object for the presented one or more content items. The tag storage provider 140 receives the request through the graphical user interface 150 and communicates with the tag component 160, which in turn communicates with the tag data store 170 to provide one or more input fields on the user interface 150. The client 110 may input one or more tags across the computer network 130 in the user interface 150 of the tag storage provider 140. The user interface 150 communicates with the tag component 160, which in turn communicates with the tag data store 170 in order to load one or more tag inputs onto a tag storage object. Methods for providing one or more input fields and receiving tag inputs in the one or more input fields will be described in further detail below with respect to the description of FIGS. 2 through 8.

FIG. 2 illustrates a flow diagram presenting a method for entering and associating one or more tags with a content item according to one embodiment of the present invention. In accordance with the embodiment of FIG. 2, the method may begin by receiving a request from a user to input one or more tags for storage in a tag storage object, step 210. As described above with respect to FIG. 1, the tag storage provider may receive this request. A graphical user interface may be provided to the user comprising one or more input fields for tag entry, step 220. The input of a tag in a given one of the one or more input fields is received, step 230, and loaded into a tag storage object for persistent storage, step 240.

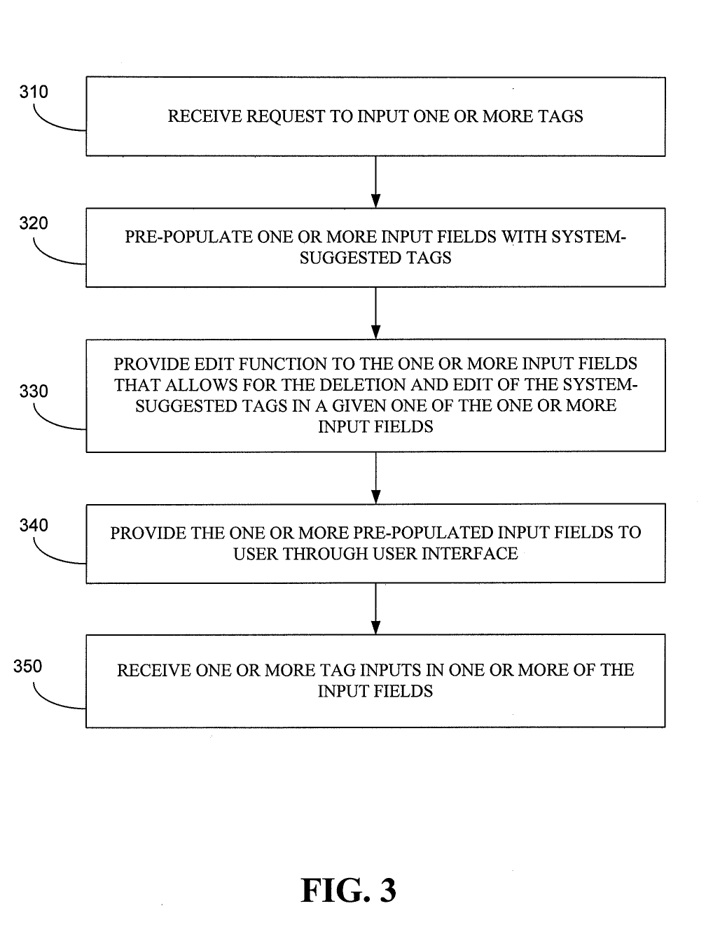

FIG. 3 illustrates a flow diagram presenting a method for entering and associating one or more tags with a content item using system-suggested tags according to one embodiment of the present invention. In accordance with the embodiment of FIG. 3, the method may begin by receiving a request from a user to input one or more tags for storage in a tag storage object, step 310. One or more input fields may then be pre-populated with system suggested tags, step 320. The tag component at the tag storage provider may communicate with the tag data store to retrieve or otherwise generate one or more system suggested tags from data stored in the tag data store. For example, the tag component 160 may generate five separate input fields and pre-populate a number of available fields with system suggested tags, e.g. “search engine”, “website”, and “mail”, which may be retrieved from the tag data store.

The one or more input fields may be provided with an edit function or control that allows for the deletion and editing of the system suggested or user provided tags in a given one of the one of the one or more input fields, step 330. For example, the edit function may allow a user to edit the pre-populated input fields. Specifically, if the first input field was pre-populated with the system-suggested tag “search engine”, the delete function would allow the user to edit the system suggested tag by the addition of terms, e.g. “a good search engine”, deletion of terms, e.g. “engine”, or deletion of the entire tag. The one or more pre-populated input fields may then be provided to the user on the user interface, step 340. The user may then choose to accept the system-suggested tags, edit the system suggested tags, or input new tags. The system receives one or more tags in one or more of the input fields for maintenance in a tag storage object, step 350.

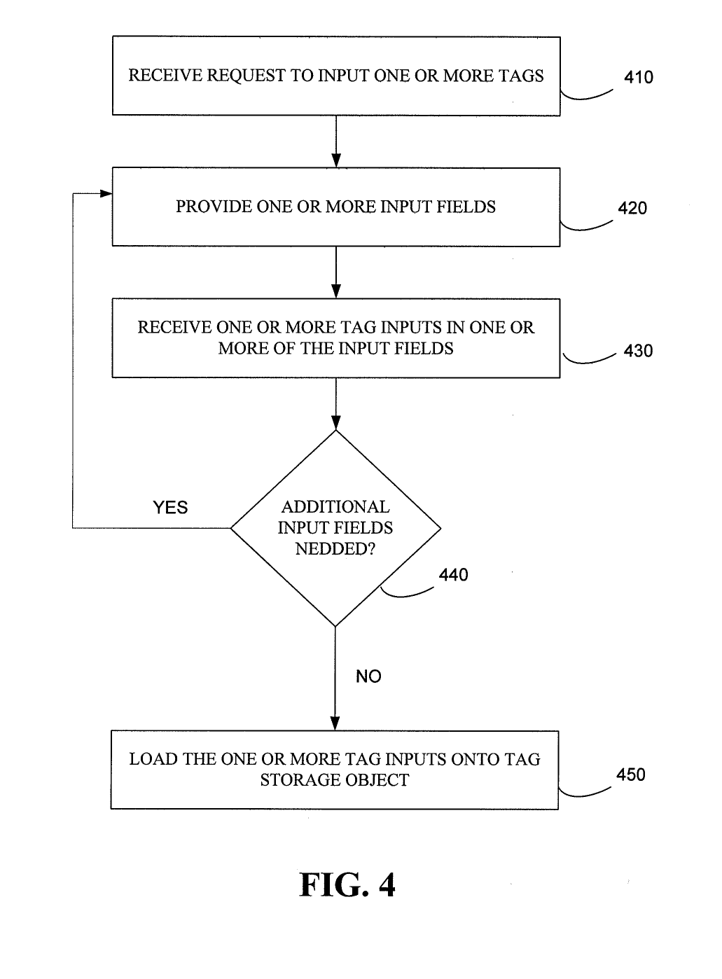

FIG. 4 illustrates a flow diagram presenting a method for providing additional input tag fields according to one embodiment of the present invention. In accordance with the embodiment of FIG. 4, the method may begin by receiving a request from a user to input one or more tags into a tag storage object, step 410, in response to which one or more input fields are provided to the user, step 420. The next step, step 430, includes receiving one or more tags input in one or more of the input fields from the user on a user interface. A determination may then made as to whether additional input fields are needed to be presented to the user, step 440. For example, the user interface at the tag storage provider may receive a tag input in each of five input fields that are originally provided, which is passed to the tag component at the tag storage provider. The tag storage provider may make a determination that additional input fields are needed, causing program flow to return to step 420. If a tag input is not received in each of the one or more input fields, then the tag component may determine that additional tag inputs are not needed and load the one or more tags into the tag storage object, step 450.

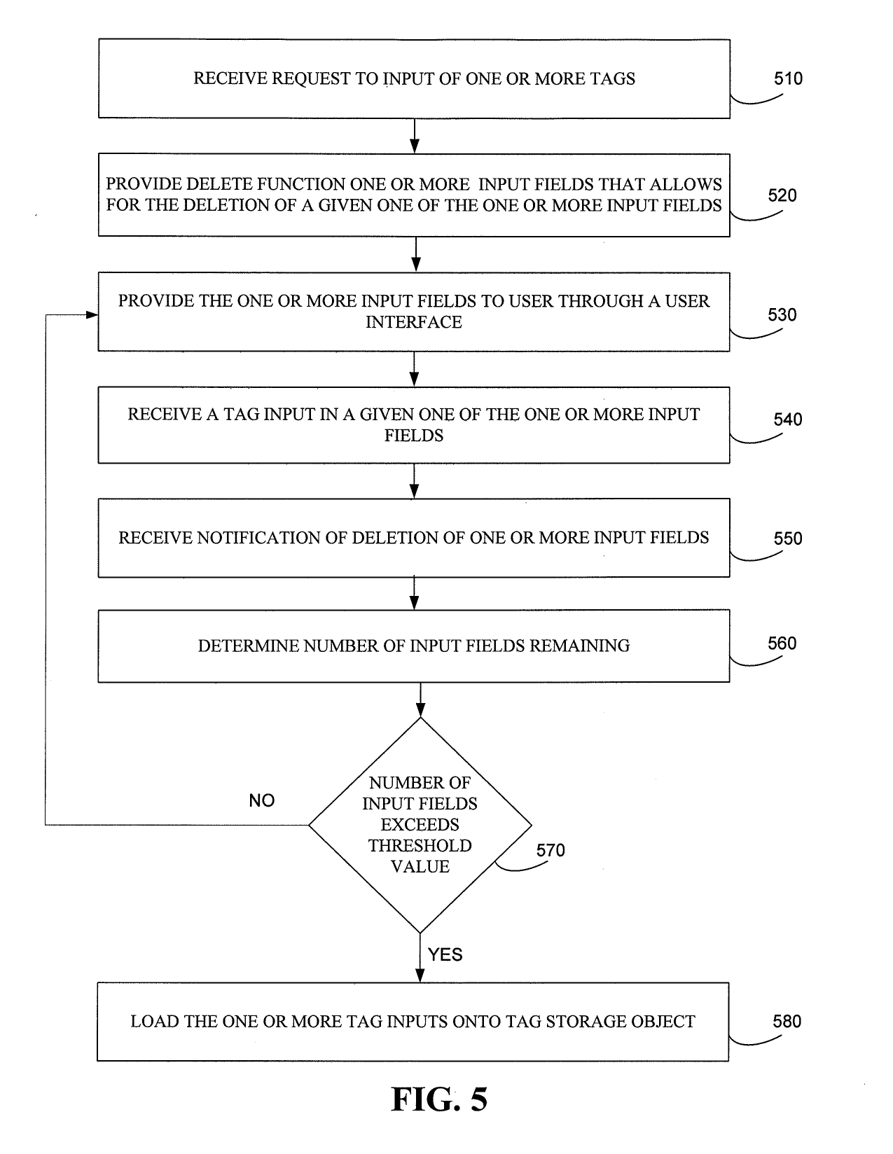

FIG. 5 illustrates a flow diagram presenting a method for providing additional input tag fields according to another embodiment of the present invention. In accordance with the embodiment of FIG. 5, the method may begin by receiving a request from a user to input one or more tags into a tag storage object, step 510. One or more input fields may be provided with a delete function that allows for the deletion of a given one of the one or more input fields, step 520. For example, the delete function may implement a delete control, e.g., a button, which may be presented in conjunction with the input field on a graphical user interface, thereby allowing a user to delete the entire input field. The one or more input fields may then be provided to the user on the user interface, step 530.

The next step, step 540, includes receiving a tag input in a given one of the one or more of the input fields. A notification of the deletion of one or more input fields may also be received, step 550, in response to which a determination may be made as to the number of input fields remaining, step 560. For example, if five input fields are originally presented to the user and the user subsequently inputs a tag into each one of the five input fields and then subsequently deletes one of the input fields, the tag component may receive the tags entered into each one of the four remaining input fields and a notification that the fifth input field has been deleted, with the resultant determination that four input fields remain. The next step, step 570, compares the number of remaining input fields to a threshold value. If the number of input fields does not exceed a threshold value, the process repeats at step 530. Continuing from the previous example, if the threshold value of input fields is five, the remaining four input fields fails to exceed the threshold value resulting in an additional input field presented to the user on the user interface. If the number of input fields does exceed a threshold value, then the one or more tags may be loaded into the tag storage object, step 580.

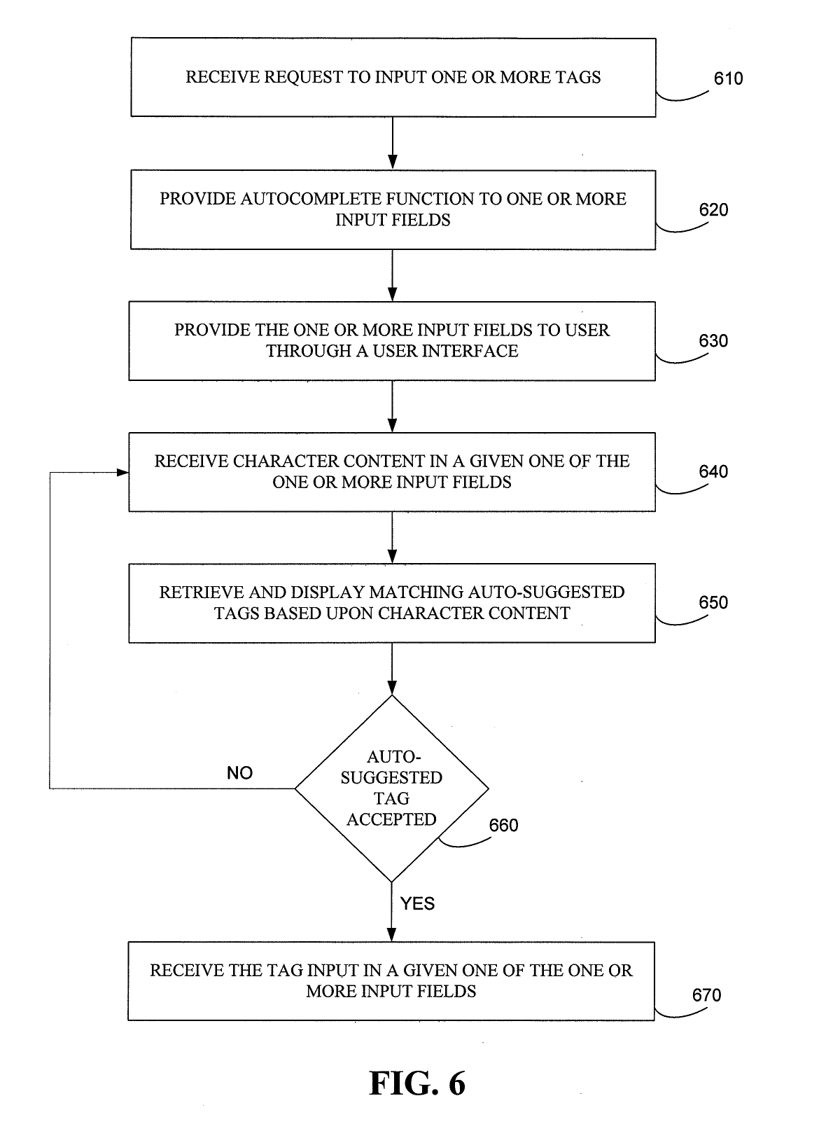

FIG. 6 illustrates a flow diagram presenting a method for entering and associating one or more tags with a content item using auto-suggested tags according to one embodiment of the present invention. In accordance with the embodiment of FIG. 6, the method may begin by receiving a request from a user to input one or more tags into a tag storage object, step 610. One or more input fields may then be provided with an AutoComplete function that provides matching auto-suggested tags that prefix-match the characters a user is entering into a given input field, step 620. Auto-suggestion of tage may be performed by the tag component that retrieves matching auto-suggested tags from the tag data store at the tag storage provider. The one or more input fields may then be provided to the user on the user interface, step 630.

The next step, step 640, includes receiving character content in a given one of the one or more input fields. For example, a user may enter into the first input field, the characters “w”, “i” and “n” (“win”). Matching auto-suggested tags based upon the character content may then be retrieved and displayed to the user, step 650. As mentioned previously, this may be performed by the tag component, which may retrieve matching auto-suggested tags from the tag data store and display the matching auto-suggested tags on the graphical user interface. Continuing from the previous example, if a user were to enter the characters “w”, “i” and “n” (“win”), matching auto-suggested tags may be retrieved from a storage component and be displayed to the user for selection. Examples of matching auto-suggested tags to the character content may include “wind”, “windows”, “wine” and “winemaking”. According to one embodiment, the matching auto-suggested tags are based upon prefix matching rules to match the character content. In another embodiment, the matching auto-suggested tags may be retrieved a tag list maintained by the user.

A determination may be made as to whether the auto suggested tag was accepted, step 660. If the user does not accept the auto-suggested tags, the process repeats at step 640. Continuing from the previous example, if the matching auto-suggested tags, “wind”, “windows”, “wine” and “winemaking”, are not selected by the user, and instead the user enters a fourth character “c”, creating the character content term “winc”, additional matching auto-suggested tags may be retrieved to match the character content “winc” utilizing the same pre-fix matching rules. For example, using pre-fix matching rules, the matching auto-suggested tag “winch” may be retrieved to match the character content “winc”, which may be displayed to the user.

If the user does accept the auto-suggested tags, the tag storage provider may receive the accepted auto-suggested tags in a given one of the one or more input fields, step 670. For example, as the user is entering the character content “winc”, the user may have intended on entering the tag “winch.” Therefore, when the user is presented with the matching auto-suggested tag “winch”, the user will accept the auto suggested. In one embodiment, the matching auto-suggested tags may be presented to the user as a drop-down menu to one or more of the tag input fields on a graphical user interface.

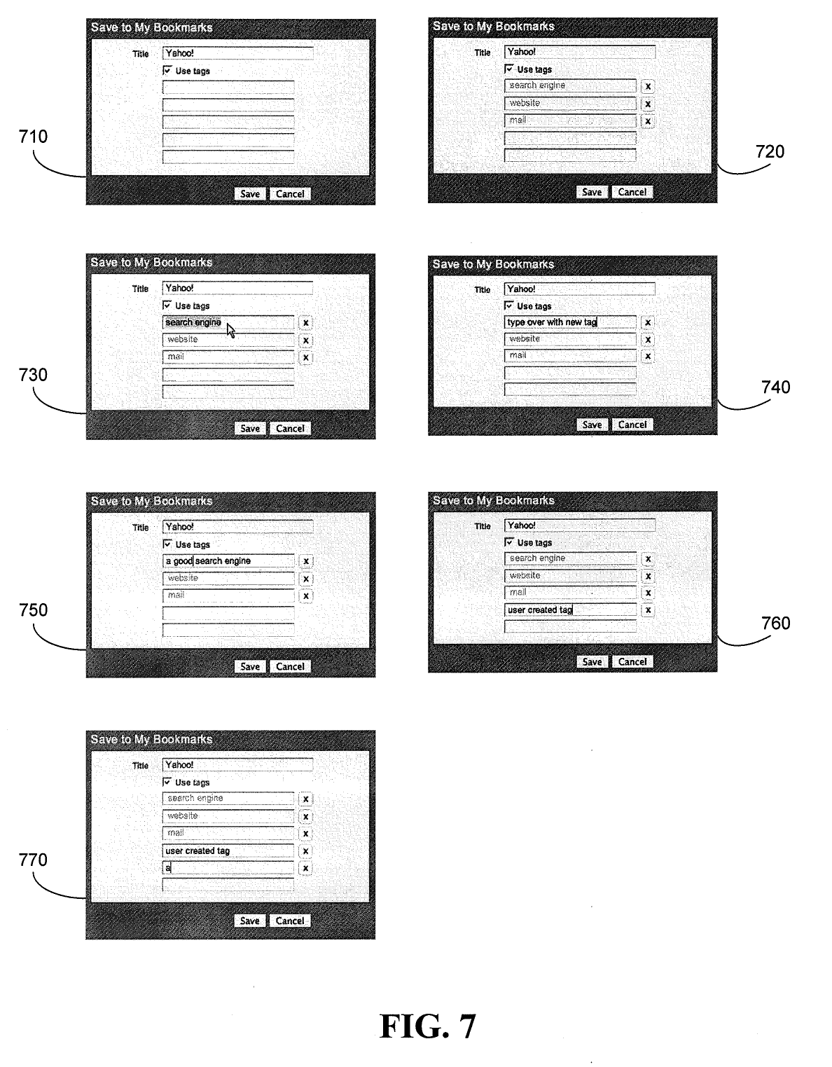

FIG. 7 illustrates a series of sample screen images exemplifying a graphical user interface for entering and associating one or more tags with a content item according to one embodiment of the present invention. Image 710 illustrates a sample screen image of a graphical user interface that may be provided to a user for associating one or more tags with a content item. As illustrated in image 710, five input fields are presented to the user which allows the user to enter a single tag in each input field and for associating individual tags with a single content item.

Image 720 illustrates a sample screen image of a graphical user interface that may be provided to a user where one or more input fields are pre-populated with system suggested tags. As illustrated in image 720, the user is presented with five input fields with the first three input fields pre-populated with a single system suggested tags, in this illustration, the tags “search engine”, “website” and “mail”. A user may have the ability to delete the entire tag by clicking on the delete icon displayed beside the input field, which allows the user when clicking on this icon to delete the entire content of the input field. For example, if the user clicks on the delete icon (the “X” button) next to the first input field containing the system suggested tag “search engine”, the tag “search engine” is removed from the input field.

A user may also have the ability to edit the content of a given tag in one or more of the input fields, as illustrated in images 730, 740 and 750. According to one embodiment, when any content in entered in a tag input field, it is highlighted, indicating the ability to edit the content, as illustrated in image 730. For example, in image 730, the first input field contains highlighted content, which is the system suggested tag “search engine”. A user may type over the content in the input field with a new a tag, as illustrated in image 740. The user may also add or delete terms to the tag, as image 750 illustrates, where the user edits the system suggested tag “search engine” to add an additional term “good,” thereby making the tag entry “a good search engine”. According to one embodiment of the invention, a user also has the ability to simply type in a tag entry into an input field that has not been pre-populated, as illustrated in image 760 where a user entered the content “user created tag” in the fourth input field. [0036] According to one embodiment, a user may have the ability to associate as many tags to a single content item as the user desires with no limit as to the number of tags that can be associated with a content item. As illustrated in image 770, the graphical user interface reflects the presence of content in all five of the originally presented input fields and therefore a sixth additional input field is presented to the user, allowing the user to enter additional tags. In the present context, the additional input field is provided on a singular basis. However, additional input fields may be provided to a user in any denomination.

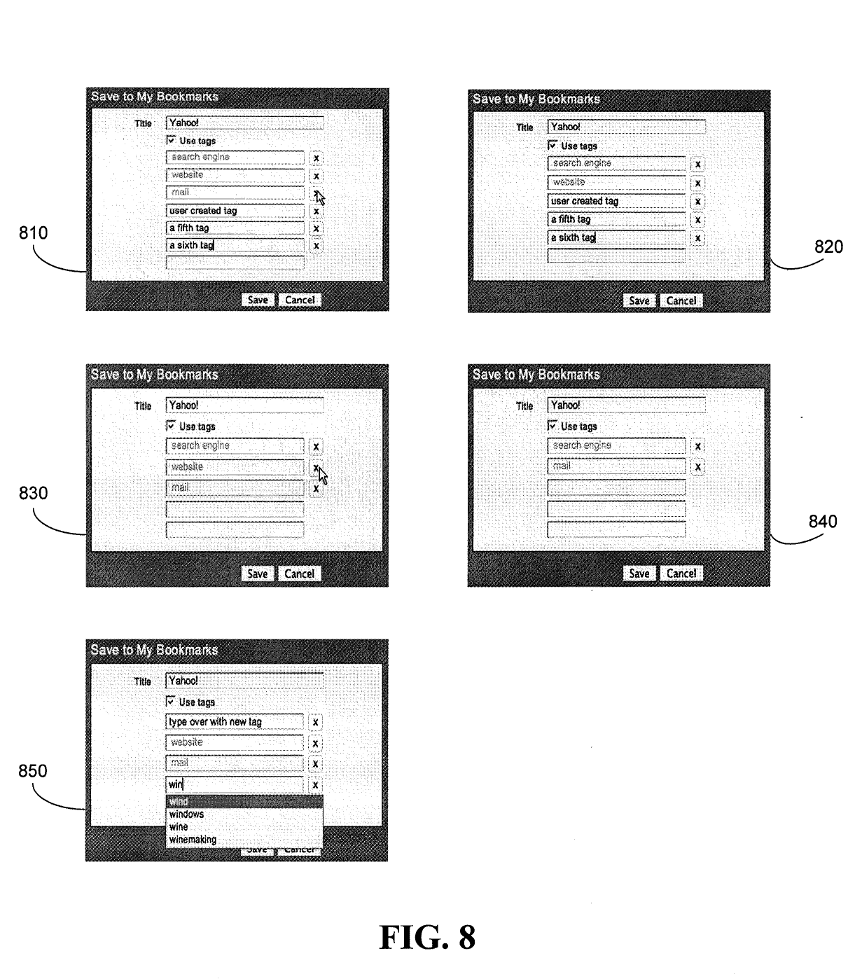

FIG. 8 illustrates a series of sample screen images exemplifying the graphical user interface for entering and associating one or more tags with a content item according to another embodiment of the present invention. Image 810 illustrates a sample screen of a graphical user interface that may be provided to a user for associating one or more tags with a content item, the graphical user interface comprising seven input fields, six of which contain tags. As discussed previously, a user may have the ability to delete a tag entry by clicking on the delete icon displayed next to the corresponding input field. For example, in image 810, a user may choose to delete the third input field which contains the tag entry “mail”. As a result, the tag entry “mail” is removed and is no longer associated with the content item. Thus, the tags “search engine”, “website”, “user created tag”, “a fifth tag” and “a sixth tag” are the only tags associated with the content item, as illustrated in image 820.

In one embodiment of the invention, additional tag input fields are presented to a user if the number of input fields are less than a threshold values. For example, if the threshold value for the number of input fields that are to be presented to a user is five, additional input fields will be presented upon the deletion of an input field where the resulting number of input fields is less than five. By way of a further example, image 830 illustrates the presence of five input fields. A user may choose to delete the second input field, containing the tag entry “website”, which would result in only four input fields remaining. As a result, an additional input field is presented to the user in the graphical user interface to display a total of five input fields, illustrated in image 840. However, if the deletion of an input field resulted in a remaining number of input fields that satisfied the threshold value, additional input fields would not be provided, e.g. image 810 and 820, where a single input field is deleted resulting in six remaining input fields.

Image 850 illustrates a sample screen image of a graphical user interface that may be provided to a user for associating one or more tags with a content item where one or more input fields are provided with matching auto-suggested tags. As illustrated in image 850, a user may begin to enter character content within the fourth input field, here the term “win”. In one embodiment, an auto-complete function retrieves potential matching tags and present these tags to the user in a drop down menu. For example, in image 850, a drop down menu is associated with the fourth input infield and displays the matching auto-suggested tags “wind”, “windows”, “wine” and “winemaking”, which are tags retrieved and displayed to the user based upon prefix matching to the character content “win”. A user may select any one of the matching auto-suggested tags and accept the tag to be associated with the content item or may ignore the auto-suggested tags and continue to enter a personal tag.

In accordance with the foregoing description, the present invention provides for an improved method of associating one or more tags with a content item by providing multiple input fields, thereby allowing an inexperienced user to input tags efficiently. The benefits of multiple input fields is to clearly indicate and suggest to users that multiple tags can be entered and applied onto an object and allow for the inclusion of characters in a given tag which would otherwise be reserved for tag-delimitation in other tag entry systems. Furthermore, the present invention allows for automatic inclusion of system suggested tags, as well as simple delete and edit functions, contrary to current tag entry systems.

FIGS. 1 through 8 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for associating one or more tags with a content item, the method comprising:
receiving a request to input one or more tags;
providing one or more tag input fields through the use of a graphical user interface;
receiving a tag input in a given one of the one or more tag input fields; and
loading the tag from a given one of the one or more tag input fields into a tag storage object for persistent storage of the tag.

2. The method of claim 1 wherein providing the one or more tag input fields comprises pre-populating the one or more tag input fields with one or more system-suggested tags.

3. The method of claim 1 wherein providing the one or more tag input fields comprises providing an edit function to the one or more tag input fields.

4. The method of claim 1 comprising:
determining whether additional input fields are needed; and
providing additional input fields on the basis of the determining step.

5. The method of claim 1 wherein the providing the one or more tag input fields comprises providing a delete function to the one or more input fields.

6. The method of claim 5 wherein the step of providing the delete function to the one or more tag input fields comprises:
receiving a notification of deletion for a given tag input field;
determining a number of tag input fields remaining;
comparing the number of input fields remaining to a threshold value; and
providing one or more additional tag input fields when the number of tag input fields remaining exceeds the threshold value.

7. The method of claim 1 wherein the providing one or more tag input fields comprises providing an auto complete function for the one or more input fields.

8. The method of claim 7 wherein the providing the auto complete function for the one or more input fields comprises:
receiving one or more characters in a given one of the one or more tag input fields;
retrieving one or more auto-suggested tags based upon a match with the one or more characters; and
displaying the one or more matching auto-suggested tags in one or more tag input fields.

9. Computer readable media comprising program code that when executed by a programmable causes execution of a method for associating one or more tags with a content item, the computer readable media comprising:
program code for receiving a request to input one or more tags;
program code for providing one or more tag input fields through the use of a graphical user interface;
program code for receiving a tag input in a given one of the one or more tag input fields; and
program code for loading the tag from a given one of the one or more tag input fields into a tag storage object for persistent storage of the tag.

10. The computer readable media of claim 9 wherein program code for providing the one or more tag input fields comprises program code for pre-populating the one or more tag input fields with one or more system-suggested tags.

11. The computer readable media of claim 9 wherein program code for providing the one or more tag input fields comprises program code for providing an edit function to the one or more tag input fields.

12. The computer readable media of claim 9 comprising:
program code for determining whether additional input fields are needed; and
program code for providing additional input fields on the basis of the determining step.

13. The computer readable media of claim 9 wherein program code for providing the one or more tag input fields comprises program code for providing a delete function to the one or more input fields.

14. The computer readable media of claim 13 wherein the program code for providing the delete function to the one or more tag input fields comprises:
program code for receiving a notification of deletion for a given tag input field;
program code for determining a number of tag input fields remaining;
program code for comparing the number of input fields remaining to a threshold value; and
program code for providing one or more additional tag input fields when the number of tag input fields remaining exceeds the threshold value.

15. The computer readable media of claim 9 wherein the program code for providing one or more tag input fields comprises program code for providing an auto complete function for the one or more input fields.

16. The computer readable media of claim 15 wherein the program code for providing the auto complete function for the one or more input fields comprises:
program code for providing receiving one or more characters in a given one of the one or more tag input fields;
program code for providing retrieving one or more auto-suggested tags based upon a match with the one or more characters; and
program code for providing displaying the one or more matching auto-suggested tags in one or more tag input fields.

17. A system for associating one or more tags with a content item, the system comprising:
a graphical user interface operative to receive a request to input one or more tags; and
a tag component operative to:
provide one or more tag input fields through the use of the graphical user interface;
receive a tag input in a given one of the one or more tag input fields; and
load the tag from a given one of the one or more tag input fields into a tag storage object for persistent storage of the tag.

18. The system of claim 17, further comprising a tag data store operative to store one or more system-suggested tags.

19. The system of claim 18, wherein the tag component is operative to provide the one or more tag input fields by pre-populating the one or more tag input fields with one or more system-suggested tags retrieved from the tag data store.

20. The system of claim 17, wherein the tag component is operative to provide the one or more tag input fields with an edit function.

21. The system of claim 17, wherein the tag component is operative to:
determine whether additional input fields are needed; and
provide additional input fields on the basis of the determination.

22. The system of claim 17, wherein the tag component is operative to provide the one or more tag input fields with a delete function.

23. The system of claim 22, wherein the tag component is operative to:
receive a notification of deletion for a given tag input field;
determine a number of tag input fields remaining;
compare the number of input fields remaining to a threshold value; and
provide one or more additional tag input fields when the number of tag input fields remaining exceeds the threshold value.

24. The system of claim 17, wherein the tag component is operative to provide one or more tag input fields with an auto complete function.

25. The system of claim 24, wherein the tag component is operative to:
receive one or more characters in a given one of the one or more tag input fields;
retrieve one or more auto-suggested tags based upon a match with the one or more characters; and
display the one or more matching auto-suggested tags in one or more tag input fields.
